(19) United States
(12) Patent Application Publication
(10) Pub. No.: US 2025/0168455 A1
(43) Pub. Date: May 22, 2025

(54) METHOD FOR DETERMINING EFFECT VIDEO, ELECTRONIC DEVICE, AND STORAGE MEDIUM

(71) Applicant: Beijing Zitiao Network Technology Co., Ltd., Haidian District, Beijing (CN)

(72) Inventor: Zhixiong LU, Beijing (CN)

(21) Appl. No.: 18/841,335

(22) PCT Filed: Feb. 6, 2023
(86) PCT No.: PCT/CN2023/074625

§ 371 Date: Aug. 23, 2024

(30) Foreign Application Priority Data
Feb. 24, 2022 (CN) 202210172557.8

(51) Int. Cl. H04N 21/472; G06T 5/77; G06T 7/13; H04N 21/431

(52) U.S. Cl. CPC H04N 21/47205; G06T 5/77; G06T 7/13; H04N 21/4312; H04N 21/4318

(57) ABSTRACT

A method for determining an effect video, an electronic device, and a non-transitory storage medium are provided. The method includes: acquiring, in response to an effect triggering operation, a current video frame to be processed; adding, for a target object in the current video frame to be processed, a target effect; and controlling, in response to meeting a linkage exhibiting condition, the target effect to be exhibited in linkage with the target object, for obtaining a target effect video.

The present application claims the priority of China Patent Application No.202210172557.8 filed on Feb. 24, 2022, the entirety of which is incorporated into the present application by reference.

### TECHNICAL FIELD

The embodiments of the present disclosure relate to the field of image processing technologies, for example, relate to a method and apparatus for determining an effect video, an electronic device, and a storage medium.

### BACKGROUND

With the continuous advancement of network technologies, an increasing number of applications have permeated users' daily lives, especially a series of software capturing short videos, which are highly favored by the users.

In order to improve the interestingness for video capturing, software developers provide various effect props for the user to select and use, thereby achieving effect videos with rich and interesting contents.

At present, the number of effect props is very limited, and the interactivity between the video content and the user is poor. Therefore, the effectiveness presented by the effects have certain limitations.

### SUMMARY

The present disclosure provides a method and apparatus for determining an effect video, an electronic device, and a storage medium.

In the first aspect, the embodiments of the present disclosure provide a method for determining an effect video, which includes:
acquiring, in response to an effect triggering operation, a current video frame to be processed;
adding, for a target object in the current video frame to be processed, a target effect; and
controlling, in response to meeting a linkage exhibiting condition, the target effect to be exhibited in linkage with the target object, for obtaining a target effect video.

In the second aspect, the embodiments of the present disclosure also provide an apparatus for determining an effect video, which includes: a video frame acquiring module, an effect adding module, and an effect linkage exhibiting module.

The video frame acquiring module is configured to acquire, in response to an effect triggering operation, a current video frame to be processed.

The effect adding module is configured to add, for a target object in the current video frame to be processed, a target effect.

The effect linkage exhibiting module is configured to control, in response to meeting a linkage exhibiting condition, the target effect to be exhibited in linkage with the target object, for obtaining a target effect video.

In the third aspect, the embodiments of the present disclosure also provide an electronic device, which includes:
at least one processor, and
a storage apparatus which is configured to store at least one program.

When the at least one program is executed by the at least one processor, the at least one processor performs the method for determining an effect video according to any embodiment of the present disclosure.

In the fourth aspect, the embodiments of the present disclosure also provide a storage medium including computer-executable instructions. When executed by a computer processor, the computer-executable instructions are used to perform the method for determining an effect video according to any embodiment of the present disclosure.

### BRIEF DESCRIPTION OF DRAWINGS

FIG. 1 is a flow schematic diagram of a method for determining an effect video provided by Embodiment 1 of the present disclosure;

FIG. 2 is a schematic diagram of a effect provided by an embodiment of the present disclosure;

FIG. 3 is a flow schematic diagram of a method for determining an effect video provided by Embodiment 2 of the present disclosure;

FIG. 4 is a flow schematic diagram of a method for determining an effect video provided by Embodiment 3 of the present disclosure;

FIG. 5 is a flow schematic diagram of a method for determining an effect video provided by Embodiment 4 of the present disclosure;

FIG. 6 is a structural schematic diagram of a device for determining an effect video provided by Embodiment 5 of the present disclosure; and

FIG. 7 is a structural schematic diagram of an electronic device provided by Embodiment 6 of the present disclosure.

### DETAILED DESCRIPTION

The embodiments of the present disclosure will be described below with reference to the accompanying drawings. Although certain of the embodiments of the present disclosure are illustrated in the accompanying drawings, it should be understood that the present disclosure may be embodied in various forms and should not be construed as limited to the embodiments set forth herein. Rather, these embodiments are provided for a thorough and complete understanding of the present disclosure. It should be understood that the accompanying drawings and embodiments of the present disclosure are only used for illustration, and are not used to limit the protection scope of the present disclosure.

It should be understood that various steps recited in the method implementation of the present disclosure may be performed in a different order and/or in parallel. Furthermore, the method implementation may include additional steps and/or omit execution of illustrated steps. The scope of the present disclosure is not limited in this respect.

As used herein, the term “including” and its variants are open-ended including, that is, “including but not limited to”. The term “based on” is “at least partially based on”. The term “one embodiment” represents “at least one embodiment”; the term “another embodiment” represents “at least one other embodiment”; and the term “some embodiments” represents “at least some embodiments”. Related definitions of other terms will be given in the following description.

It is required to be noted that the concepts such as “first”, “second” and the like mentioned in the present disclosure are only used to distinguish between different devices, modules or units, and are not used to limit the order or interdependence of functionalities performed by such devices, modules or units.

It is required to be noted that the modifications such as “a”, “a plurality of” and the like mentioned in the present disclosure are schematic rather than limiting, and it should be understood by those skilled in the art as “one or more”, unless otherwise indicated by the context.

The names of messages or information exchanged among multiple devices in the embodiments of the present disclosure are only used for illustrative purposes, and are not used to limit the scope of such messages or information.

Before introducing this embodiment, an application scenario may be first exemplarily illustrated. The embodiment of the present disclosure can be applied to any picture that requires the effect exhibition, for example, can be applied to a case that the image corresponding to the user being shot may be subjected to an effect processing during video shooting, such as in a short video shooting scenario.

In this embodiment, a linkage between a target object and a target effect can be implemented while capturing the target object using the corresponding application software.

### Embodiment 1

FIG. 1 is a flow schematic diagram of a method for determining an effect video provided by Embodiment 1 of the present disclosure. This embodiment can be applied to a linkage between a target effect and a target object in any image exhibiting scenario supported by the Internet. The method may be performed by an apparatus for determining an effect video. The apparatus may be implemented in the form of software and/or hardware, which may be an electronic device, such as a mobile terminal, a Personal Computer (PC) terminal or a server, etc. Any image exhibiting scenario is usually implemented by cooperation between a client and a server. The method provided by this embodiment may be performed by the server, the client, or the cooperation between the client and the server.

As illustrated in FIG. 1, the method of this embodiment includes:

S110: acquiring, in response to an effect triggering operation, a current video frame to be processed.

The apparatus for performing the method for determining an effect video provided by the embodiments of the present disclosure may be integrated in the application software supporting effect image processing functions, which may be installed in the electronic device. For example, the electronic device may be a mobile terminal or a PC terminal. The application software may be a kind of software for processing images/videos, which is not described in detail herein, as long as the image/video processing can be implemented. The application software may also be either a specially developed application program for adding and exhibiting effects, or be integrated into a corresponding interface to enable the user to implement the addition of effects through the interface integrated in the PC terminal.

In this embodiment, in the application software or application program supporting effect image processing functions, a control for triggering effects may be developed in advance. When detecting that the control is triggered by the user, the triggering operation for effects is responded, thereby the corresponding effects video is determined.

The corresponding video frame in response to the triggering operation for effects is taken as the video frame to be processed. For example, the video frame corresponding to the time point when the effect control is triggered by the user is taken as the current video frame to be processed.

It can be understood that when the user is shooting a short video, an effect display panel may be popped up based on the effect selecting control triggered by the user. A plurality of effect props may be displayed in the s effect display panel. The user may select a required effect prop from the plurality of effect props and take it as the target effect. Meanwhile, the video frame to be processed acquired in response to the effect triggering operation is taken as the current video frame to be processed.

In this embodiment, the effect triggering operation includes at least one of: triggering a target effect prop; the monitored voice information including a linkage effect instruction; and detecting that the display interface includes a face image.

In actual application, when an effect adding prop is triggered by the user, a plurality of effects to be added may be displayed, and the effect prop triggered by the user is taken as the target effect.

It is also possible to capture voice information based on a microphone array deployed on the terminal device, and then analyze and process it. If the processing result includes a word or sentence for effect linkage, it means that an effect adding function is triggered. The advantage of determining whether to add effects based on the content of voice information is that the interaction between the user and the display interface is avoided and the intelligence for adding effects is improved. Another implementation may be to determine, according to a shooting field of view for the mobile terminal, whether a face image of the user is included within the field of view. When a face image of the user is detected, the application software may take such an event of detecting the face image as the effect triggering operation. It should be understood by those skilled in the art that what event to be selected as the effect triggering operation can be set according to actual situation, which is not limited here by the embodiments of the present disclosure.

S120: adding, for a target object in the current video frame to be processed, a target effect.

The video frame to be processed may be an image collected based on the application software. For example, in a live streaming scenario or a short video shooting scenario, a camera device may collect an image including the target object in a target scenario in real time. The image collected by the camera device in response to the effect triggering operation may be taken as the video frame to be processed. The target object included in the target scenario may be the user, an animal, a flower or a tree, and etc.

It should be noted that the number of target objects in a same shooting scenario may be one or more, and no matter it is one or more, the embodiments provided by the present disclosure can be used to determine an effect video frame.

It should also be noted that before shooting an effect video, a target object may be set in advance so that upon detecting that the current video frame to be processed includes the target object, a target effect can be added for the target object.

In this embodiment, the target effect may be any floatable effect. For example, a floating effect may be a kite, a balloon, cotton wool, a UFO, an airplane and so on. The number of balloons may be one or more. The advantage of adding any floating effect is that it can simulate the effectiveness of the linkage between the floating effect and the user in a real environment.

For example, after the current video frame to be processed is acquired, any floating effect may be added for the target object in the video frame to be processed.

Exemplarily, the target effect added for the target object is multiple balloons, which are mounted on the user's head or shoulder via multiple strings.

S130: controlling, in response to meeting a linkage exhibiting condition, the target effect to be exhibited in linkage with the target object, for obtaining a target effect video.

For example, the linkage exhibiting condition is used to characterize a condition for whether the target effect jointly moves with the target object. The target effect is composed of a plurality of effect video frames. Each of the effect video frames includes a target effect and a target object. If the target effect and the target object are taken as a whole, in different effect video frames, there is a difference between the display positions of the target effect and the target object.

In this embodiment, the linkage exhibiting condition includes at least one of: a triggering operation on a display interface to which the video frame to be processed belongs; there being no triggering operation on a display interface to which the current video frame to be processed belongs within a preset duration; a target limb action of the target object being consistent with a preset limb action; and a preset wake-up word being triggered by actual audio information of the target object.

It can be understood that the linkage exhibiting condition include at least one of the above, and various linkage exhibiting conditions are introduced next.

The first linkage exhibiting condition may be: adding a target effect for a target object. If an exhibition in linkage is required, any position on the display interface to which the target object belongs may be triggered. Upon detecting the triggering on the display interface, it means that the exhibition in linkage is triggered. That is, an effect video with the target object and the target effect exhibited in linkage may be obtained.

The second linkage exhibiting condition may be: recording the duration of continuous exhibition of the target effect after adding the target effect for the target object in order to improve the intelligence of effect video production in actual application. If the duration of the continuous exhibition reaches a preset exhibiting duration threshold, i.e., the preset duration, no matter whether the triggering operation on the display interface is detected, it means that it is required to adjust the linkage between the target object and the target effect.

The third linkage exhibiting condition may be: determining limb action information of the target object in the current video frame to be processed based on a feature point recognition algorithm. If the limb action information is consistent with the preset limb action, it means that the linkage exhibiting condition is triggered. The preset limb action may be: a posture with both arms up, etc.

The fourth linkage exhibiting condition may be: acquiring audio information of the target object in real time. If it is determined according to the audio information that a wake-up word for exhibition in linkage is triggered by the target object, it means that the exhibition in linkage is required. The preset wake-up word may be: floating, taking-off, linkage, and etc.

It can be seen based on the above approaches that, as long as one or more of the above linkage exhibiting conditions are met, it means that it is required to adjust the exhibition in linkage of the target object and the target effect.

In this embodiment, the exhibition in linkage may be a joint floating exhibition of the target object and the target effect in the same frequency and in the same amplitude.

For example, after the target effect is added for the target object, it may be detected whether the linkage exhibiting condition is met, and if so, the target object is controlled in the current video frame to be floating exhibited in the same frequency or in the same amplitude with the target effect.

It should also be noted that the attitude information of the target object in the current video frame to be processed is the initial effect video frame in the effect video. While determining respective effect video frames in sequence, the attitude information of the target object in the effect video frame can be adjusted according to the attitude information of the target object in the actual scenario.

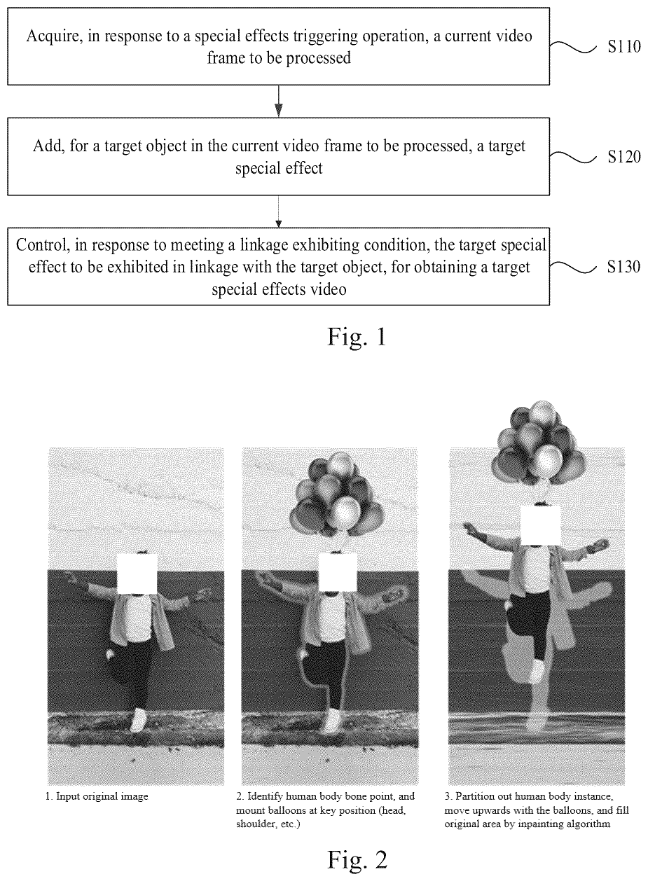

Exemplarily, after a floating effect prop is triggered, a floating effect displayed may be balloons. The schematic diagram illustrated by 1 in FIG. 2 is shot based on the terminal device, that is, the original image is obtained. A mount point in the original image is determined based on the image recognition algorithm. For example, the mount point may be the head, the shoulder, etc. As illustrated by 2 in FIG. 2, the mount point may be the head. That is, a pulling effect for the floating effect may be mounted on the head. In the process of the linkage between the floating effect and the target object, pixel points required to be filled may be determined and then be filled, thereby obtaining 3 in FIG. 2.

The embodiment of the present disclosure may add, by responding to an effect triggering operation, a target effect for a target object in the current video frame to be processed with the acquired current video frame to be processed taken as an initial effect video frame, and control the target effect to be exhibited in linkage with the target object, for obtaining a target effect video with the current video frame to be processed as the initial effect video frame, thereby realizing the interactivity between the effect video content and the user, which not only improves the richness of the video picture content, but also enhances the interactivity with the user.

### Embodiment 2

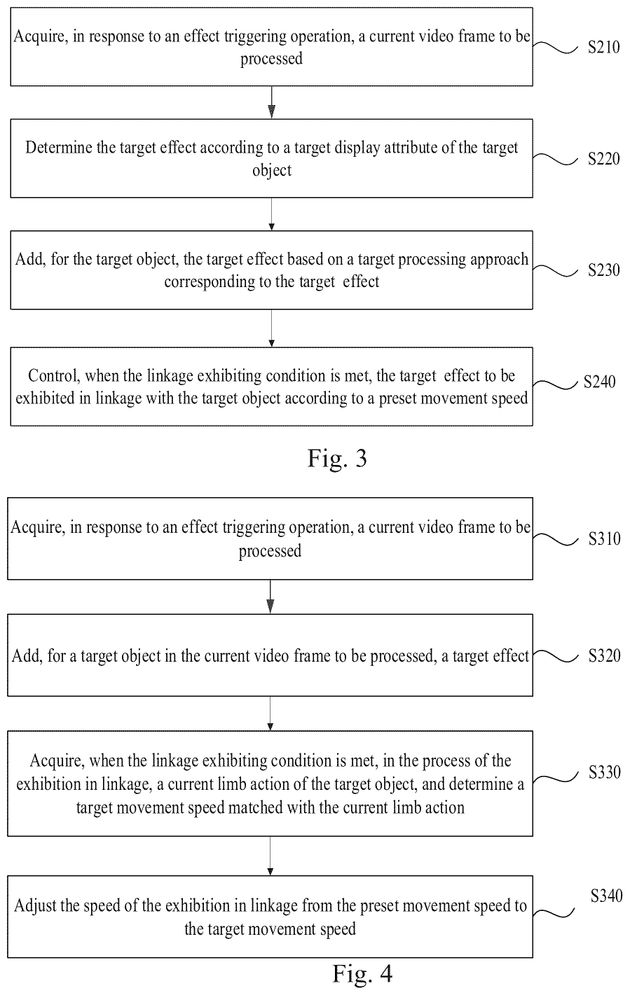

FIG. 3 is a flow schematic diagram of a method for determining an effect video provided by Embodiment 2 of the present disclosure. On the basis of the aforementioned embodiment, adding a target effect for a target object in the current video frame to be processed further requires to be in combination with a target display attribute of the target object. The implementation can be refer to this embodiment. The technical terms that are the same as or corresponding to those in the above embodiment are not detailed herein.

As illustrated in FIG. 3, the method includes the following steps:

S210: acquiring, in response to an effect triggering operation, a current video frame to be processed.

S220: determining the target effect according to a target display attribute of the target object.

The target display attribute includes at least one of a local display attribute and/or a global display attribute. The local display attribute is that only local information of the target object is displayed in the current video frame to be processed. The local information may be face, torso, etc. Accordingly, the global display attribute is that complete information of the target object is displayed in the current video frame to be processed. If the torso's display ratio for the target object in the video frame to be processed is more than 50%, the display attribute of the target object is determined as the global display attribute. The display attribute is determined for being able to invoke corresponding processing methods for target objects according to different display attributes and add for the target objects corresponding effects. If the number of target objects in the current video frame to be processed is one, the target display attribute may be the local display attribute or the global display attribute; or if the number of target objects in the current video frame to be processed is more than one, it is required to determine the target display attribute for each target object, respectively, and further, to determine the target effect corresponding to the each target object.

It can be understood that after the current video frame to be processed is acquired, the target display attributes of the respective target objects in the current video frame to be processed may be determined. Based on the target display attributes corresponding to the respective target objects, the corresponding target effect are determined.

S230: adding, for the target object, the target effect based on a target processing approach corresponding to the target effect.

The target processing approach is consistent with the target display attribute. The target processing approach is a processing approach for processing a corresponding target object. After the target effect is determined, the target effect may be added to the target object in the current video frame to be processed based on the target processing approach consistent with the target display attribute.

For example, if the number of target objects in the current video frame to be processed is one, the target processing approach is determined according to the target display attribute of the target object, and a target effect is added for the target object based on the target processing approach. If the number of target objects in the current video frame to be processed is multiple, corresponding target processing approaches are determined according to target display attributes of the respective target objects, respectively. The target effects are added for corresponding target objects based on respective target processing approaches. It should also be noted that if a target object is set in advance, even if there are more than one objects in the current video frame to be processed, only the pre-labeled target object is subjected to the effect processing, for obtaining 1 effect video frames for which the effects are added only for some of the users.

In the embodiment of the present disclosure, there are two kinds of target display attributes, so the target processing approach also include the processing approach s corresponding to local display attribute and global display attribute respectively.

In an example, if the target effect is consistent with the global display attribute, then a target limb key point corresponding to the target object is determined; the target limb key point is determined as a mount point of the target effect, and the target effect is added for the target object.

The recognition may be performed on the target object by adopting a bone point recognition algorithm, or based on a bone recognition model, so as to determine a limb key point of the target object. The target limb key point may be a preset mount point. For example, the pre-set mount point is the shoulder or the head. After the limb key point is determined by adopting the bone point recognition algorithm, the shoulder or the head may be taken as the target limb key point, i.e., a target effect mount point. The target effect is mounted at the effect mount point. The target effect may be any effect that can fly up, such as a balloon, a kite, and a bird as simulated in a real scenario, optionally, an eagle.

In this embodiment, if the display attribute of the target object is the local display attribute, the target processing approach is determined as: determining a partitioned sub-image corresponding to the target object, and taking the partitioned sub-image as display content in the target effect.

For example, the reason for the existence of the local display attribute is that the video frame to be processed can be an image uploaded by the user, or an image only including the head shot by the user based on a mirroring effect, in this case, the display attribute is the local display attribute. In the case of local display attribute, it means that the current video frame to be processed only includes a local part of the target object. Usually, the local part is mainly the upper body. The partitioned sub-image may be the head image of the target object, which includes facial features of the target object. The partitioned sub-image may be determined by adopting a human body partition model, face partition model or partition algorithm. After the head image is determined, the head image may be displayed in a central area of the target effect or a preset area. The target display content is an interface schematic diagram of the head image displayed in the target effect.

It should be noted that no matter whether the target display attribute is the local display attribute or the global display attribute, the target effects adopted are the same, except that the relative display approaches for the target effects and the target objects are different. The display approach corresponding to the local display attribute is to display the face image in the central area of the target effect or in the preset area. The display approach corresponding to the global display attribute is to mount the target effect at the target mount point.

S240: controlling, when the linkage exhibiting condition is met, the target effect to be exhibited in linkage with the target object at a preset movement speed.

The movement speed for the linkage of the target object after being added the target effect may be taken as the preset movement speed. The preset movement speed may include a magnitude of speed and a direction. The magnitude of speed is determined based on a preset effect. The direction may be determined by simulating information in the real environment. For example, the preset movement speed in the real scenario under the weather such as breeze, stroke, gale, rainy day and snowy day is differently determined. When the video frame to be processed is acquired, environmental information corresponding to the video frame to be processed may be determined, and the corresponding preset movement speed may be determined according to the environmental information. The collection of environmental information may be determined by sensors deployed on the terminal device, or by retrieving weather information from weather software.

For example, after the preset movement speed is determined based on the above approach, based on the preset movement speed, the target object and the target effect may be controlled to be in linkage.

The embodiment of the present disclosure, after the video frame to be processed is acquired in response to the effect triggering operation, may determine a processing approach for a video frame to be processed according to a target display attribute of a target object in the video frame to be processed, and further add a target effect for the target object based on the corresponding processing approach, which realizes the pertinence for the effect processing, and meanwhile, and also control the target object and the target effect to be in linkage, thereby improving the interactivity for effects.

### Embodiment 3

FIG. 4 is a flow schematic diagram of a method for determining an effect video provided by Embodiment 3 of the present disclosure. On the basis of the aforementioned embodiments, during controlling the target effect to be exhibited in linkage with the target object at the preset movement speed, it is also possible to collect the video frame to be processed including the target object in real time, so that the corresponding video background can be updated during the exhibition in linkage. The implementation can refer to the elaboration of this embodiment. The technical terms that are the same as or corresponding to those in the above embodiment are not detailed herein.

As illustrated in FIG. 4, the method includes:

S310: acquiring, in response to an effect triggering operation, a current video frame to be processed.

S320: adding, for a target object in the current video frame to be processed, a target effect.

S330: when the linkage exhibiting condition is met, in the process of the exhibition in linkage, acquiring a current limb action of the target object, and determining a target movement speed matched with the current limb action.

It can be understood that during the exhibition in linkage, it is also possible to shoot, based on the terminal device, the video frame to be processed including the target object, and to acquire the limb action information of the target object in the video frame to be processed, i.e., the current limb action. If the current limb action matches a preset speed adjusting action, the target movement speed corresponding to the current limb action is determined, and the preset movement speed during the linkage is adjusted to the target movement speed.

When the preset speed adjusting action is an action of making a stop sign with both hands, then the target movement speed is 0. When the preset adjustment action is an action of superman-like flying up, i.e., putting one arm upward, it means that acceleration is required, and the target movement speed is greater than the preset movement speed. When the preset adjustment action is an action of slowly moving, i.e., hanging both arms down, it means that deceleration is required, and the target movement speed is less than the preset movement speed.

It should be noted that in order to improve the intelligent control for the speed of linkage movement, it is also possible to capture the voice information of the target object, and to adjust the target movement speed during the linkage according to an instruction in the voice information such as rising, accelerating, decelerating and keeping a uniform speed.

S340: adjusting the speed of the exhibition in linkage from the preset movement speed to the target movement speed.

For example, the speed of the exhibition in linkage of the target object and the target effect is adjusted from the preset movement speed to the target movement speed. The target movement speed may be greater than, less than or equal to the preset movement speed.

The embodiment of the present disclosure, during the exhibition in linkage, can update the attitude information of the target object in the effect video frame, and adjust the speed of linkage movement according to the attitude information, so as to realize a dynamic adjustment of the exhibition in linkage.

On the basis of the above various embodiments, during the exhibition in linkage, a situation where the target object is not be in the display interface may occur, that is, if the exhibition in linkage is floating upward, a situation where the target object leaves the shot may occur. In order for a better transition of screen effect, the display ratio of the target object in the display interface may be adjusted according to movement height information of the target object during the exhibition in linkage. For example, the movement height information may be a movement distance from the starting position. Generally, the higher the movement distance, the smaller the display ratio is. That is, the display ratio is inversely proportional to the movement distance. The advantage of this setting is that it is possible to simulate a floating effect in the real scenario and improve the effectiveness of realism for scenario.

On the basis of the above various embodiments, during the exhibition in linkage, there is also a scenario where the target object leaves the shot and then re-enters the shot. In this situation, the measures that can be taken are: controlling, if it is detected that the target object re-enters the display interface, the target effect to be exhibited in linkage with the target object.

It can be understood as: in the scenario of exhibition in linkage, if the target object re-enters the shot, the target effect can be added for the target object again.

On the basis of the above embodiment, the method further includes: if the number of objects to be processed in the current video frame to be processed is more than one, determining the target object to add the target effect for the target object, and controlling the target effect to be exhibited in linkage with the target object.

It can be understood that: in actual application, the number of objects in the shot may be more than one. In the situation of more than one objects, the object with the largest display ratio in the display interface may be taken as the target object. It is also possible to take all the objects in the shot as the target objects. It is also possible to set a target object in advance. For example, when multiple objects are included in the shot, the target object may be determined from the multiple objects based on a feature point matching algorithm or a face image matching algorithm. The advantage of such approach is that an efficient control over the addition of effects on the display interface can be realize, which not only improves the cleanliness for the picture, but also improves the effectiveness of convenience for effect control.

It should be noted that the background information of the effect video frame is consistent with the background information while capturing the target object. For example, the background information of each of the effect video frames in the target effect video is consistent with the background information while capturing the target object.

The embodiment of the present disclosure, during the exhibition in linkage, can not only update the background image of the effect video frame in real time, but also adjust the corresponding movement speed according to the attitude information of the target object in the video frame, thereby achieving the real-time change in effect and further improving the usage experience for the user.

### Embodiment 4

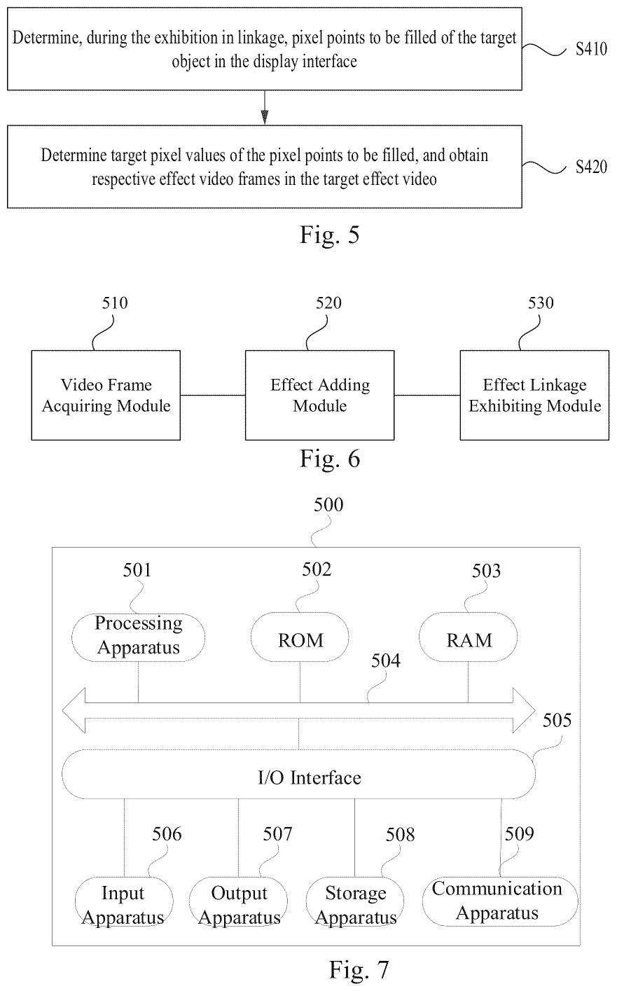

FIG. 5 is a flow schematic diagram of a method for determining an effect video provided by Embodiment 4 of the present disclosure. On the basis of the aforementioned embodiments, in order to avoid the white screen or image unclarity in the movement area during the exhibition in linkage, the pixel points in the movement area may be filled during the exhibition in linkage. The implementation can refer to the elaboration of this embodiment. The technical terms that are the same as or corresponding to those in the above embodiment will no more be detailed herein.

As illustrated in FIG. 5, the method includes:

S410: determining, during the exhibition in linkage, pixel points to be filled of the target object in the display interface.

The pixel points in the moving area during the target object linkage are taken as the pixel points to be filled.

S420: determining target pixel values of the pixel points to be filled, and obtaining respective effect video frames in the target effect video.

The pixel values required to be filled for the pixel points to be filled are taken as the target pixel values.

In this embodiment, one approach to determine the pixel points to be filled may be: when the target display attribute is a global display attribute, determining, according to display information of the target object in the previous effect video frame and the current effect video frame, the pixel points to be filled; and when the target display attribute is a local display attribute, determining, according to display information of the target effect in the previous effect video frame and the current effect video frame, the pixel points to be filled.

For example, the pixel points to be filled in each of the video frames may be determined in combination with the previous effect video frame and the current effect video frame. When the target object is of the global display attribute, it means that the target object needs to move as a whole. In this case, the determining may include: determining the position information of the target object in the previous effect video frame and the position information of the target object in the current effect video frame, so as to determine the moving area for the target object. The pixel points in the moving area are taken as the pixel points to be filled. When the target object is of the local display attribute, the head image of the target object is added to the target effect. In this case, the position information of the target effect in the previous effect video frame and the position information of the target effect in the current effect video frame may be determined, and the pixel points to be filled may be determined based on both position information.

It should be noted that the position information corresponds to the above-mentioned display information.

In the embodiment of the present disclosure, after the pixel points to be filled are determined, the target pixel values of respective pixel points to be filled may be determined to optimize the current effect video frame. For example, edge pixel points are determined according to the respective pixel points to be filled; for each of the edge pixel points, respective pixel values within the neighborhood of the current edge pixel point are determined, and the target pixel value of the current edge pixel point are determined based on the respective pixel values; filled pixel values of the respective pixel points to be filled are determined based on the target pixel values of respective edge pixel points, and are taken as the target pixel values; and an effect video frame in the target effect video is obtained based on respective target pixel values.

For example, according to the respective pixel points to be filled, a moving contour may be determined. The pixel points corresponding to the moving contour are taken as the edge pixel points. For each of the edge pixel points, the pixel values of respective pixel points not to be filled within the neighborhood (e.g., which is a pixel point) of the current edge pixel point are acquired. The pixel values are averaged to determine the target pixel value of the current edge pixel point. For the pixel points to be filled of the same row and the same column, interpolation may be performed according to the target pixel values of the edge pixel points, for obtaining the target pixel values of the pixel points to be filled of the same row and the same column. After the respective target pixel values are obtained, the filling may be performed to obtain a modified effect video frame.

The embodiment of the present disclosure, during the movement in linkage, may determine the pixel points to be filled in real time, and determine the target pixel values corresponding to the pixel points to be filled, so as to fill the corresponding pixel points to be filled based on the target pixel values, which avoids the situation of blurred screen in the display interface, and improves the quality of the effect picture.

### Embodiment 5

FIG. 6 is a structural schematic diagram of a device for determining an effect video provided by Embodiment 5 of the present disclosure. As illustrated in FIG. 6, the apparatus includes a video frame acquiring module 510, an effect adding module 520, and an effect linkage exhibiting module 530.

The video frame acquiring module 510 is configured to acquire, in response to an effect triggering operation, a current video frame to be processed. The effect adding module 520 is configured to add, for a target object in the current video frame to be processed, a target effect. The effect linkage exhibiting module 530 is configured to control, in response to meeting a linkage exhibiting condition, the target effect to be exhibited in linkage with the target object, for obtaining a target effect video.

On the basis of the above embodiment, the effect adding module includes the first processing unit, and the second processing unit.

The first processing unit is configured to determine the target effect according to a target display attribute of the target object. The target display attribute includes at least one of a global display attribute or a local display attribute.

The second processing unit is configured to add, for the target object, the target effect based on a target processing approach corresponding to the target effect.

On the basis of the above embodiments, the second processing unit is further configured to: determine, in response to the target effect being consistent with the global display attribute, a target limb key point corresponding to the target object; and determine the target limb key point as a mount point of the target effect, and add the target effect for the target object.

On the basis of the above embodiments, the second processing unit is further configured to: determine, in response to the target effect being consistent with the local display attribute, a partitioned sub-image corresponding to the target object; and determine the partitioned sub-image as target display content in the target effect.

On the basis of the above embodiment, the linkage exhibiting condition includes at least one of:
a triggering operation on a display interface to which the current video frame to be processed belongs; there being no triggering operation on a display interface to which the current video frame to be processed belongs within a preset duration; a target limb action of the target object being consistent with a preset limb action; and a preset wake-up word being triggered by actual audio information of the target object.

On the basis of the above embodiments, the effect linkage exhibiting module is further configured to: control the target effect to be exhibited in linkage with the target object at a preset movement speed.

On the basis of the above embodiments, the effect linkage exhibiting module is further configured to: acquire a current limb action of the target object, and determine a target movement speed matched with the current limb action; and adjust the speed of the exhibition in linkage from the preset movement speed to the target movement speed.

On the basis of the above embodiments, the effect linkage exhibiting module is further configured to: adjust, during the exhibition in linkage and according to movement height information of the target object, a display ratio of the target effect and the target object in the display interface.

On the basis of the above embodiments, the effect linkage exhibiting module is further configured to: control, in response to detecting that the target object re-enters the display interface, the target effect to be exhibited in linkage with the target object.

On the basis of the above embodiment, the apparatus further includes a pixel point determining unit and a pixel value determining unit.

The pixel point determining unit is configured to: determine, during the exhibition in linkage, pixel points to be filled of the target object in the display interface. The pixel value determining unit is configured to determine target pixel values of the pixel points to be filled, and obtain respective effect video frames in the target effect video.

On the basis of the above embodiments, the pixel point determining unit is configured to: determine, in response to the target display attribute being a global display attribute the pixel points to be filled according to display information of the target object in the previous effect video frame and the current effect video frame; and determine, in response to the target display attribute being a local display attribute, the pixel points to be filled according to display information of the target effect in the previous effect video frame and the current effect video frame.

On the basis of the above embodiments, the pixel value determining unit is configured to: determine, according to the respective pixel points to be filled, edge pixel points; determine, for each of the edge pixel points, respective pixel values within the neighborhood of the current edge pixel point, and determine, based on the respective pixel values, the target pixel value of the current edge pixel point; determine, based on the target pixel values of respective edge pixel points, filled pixel values of the respective pixel points to be filled, and take the filled pixel values as the target pixel values; and obtain, based on the respective target pixel values, an effect video frame in the target effect video.

On the basis of the above embodiments, the background information of each of the effect video frames in the target effect video is consistent with the background information while collecting the target object.

On the basis of the above embodiments, the apparatus further includes a target object marking module. The target object marking module is configured to determine, in response to the number of objects to be processed in the current video frame to be processed is more than one, the target object to add the target effect for the target object, and control the target effect to be exhibited in linkage with the target object.

The embodiment of the present disclosure, by responding to an effect triggering operation, can add for a target object in the current video frame to be processed a target effect with an acquired current video frame to be processed taken as an initial effect video frame, and control the target effect to be exhibited in linkage with the target object, for obtaining a target effect video with the current video frame to be processed as the initial effect video frame, thereby realizing the interactivity between the effect video content and the user, which not only improves the richness of the video picture content, but also enhances the interactivity with the user.

The device for determining an effect video provided by the embodiment of the present disclosure can perform the method for determining an effect video provided by any of the embodiments of the present disclosure, and has corresponding functional modules and beneficial effectiveness.

It is worth noting that various units and modules included in the above device are only divided according to functional logic, but are not limited to the above division, as long as corresponding functions can be realized. Additionally, the specific names of various functional units are only for the convenience of distinguishing from each other, and are not used to limit the protection scope of the embodiments of the present disclosure.

### Embodiment 6

FIG. 7 is a schematic structural diagram of an electronic device provided in Embodiment 6 of the present disclosure. Referring to FIG. 7, FIG. 7 illustrates a schematic structural diagram of an electronic device 500 (e.g., the terminal device and server in FIG. 7) suitable for implementing the embodiments of the present disclosure. The electronic device in the embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 7 is merely an example, and should not pose any limitation to the functions and the range of use of the embodiments of the present disclosure.

As illustrated in FIG. 7, the electronic device 500 may include a processing apparatus 501 (e.g., a central processing unit, a graphics processing unit, etc.), which can perform multiple suitable actions and processing according to a program stored in a read-only memory (ROM) 502 or a program loaded from a storage apparatus 508 into a random-access memory (RAM) 503. The RAM 503 further stores multiple programs and data required for operations of the electronic device 500. The processing apparatus 501, the ROM 502, and the RAM 503 are interconnected by means of a bus 504. An input/output (I/O) interface 505 is also connected to the bus 504.

Usually, the following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 7 illustrates the electronic device 500 having multiple apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

Names of messages or information exchanged among multiple apparatuses in the embodiments of the present disclosure are only used for illustrative purposes, and are not used to limit the scope of these messages or information.

The electronic device provided by the embodiments of the present disclosure belongs to the same inventive concept as the method for determining an effect video provided by the above embodiments, and the technical details which are not described in detail in this embodiment can be found in the above embodiments, and this embodiment has the same effects as the above embodiments.

### Embodiment 7

The embodiment of the present disclosure provides a computer storage medium on which a computer program is stored. When the computer program is executed by a processor, the method for determining an effect video provided in the above embodiments is performed.

The above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. Examples of the computer-readable storage medium may include but not be limited to: an electrical connection with one or more wires, a portable computer disk, a hard disk, a RAM, a ROM, an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:
acquire, in response to an effect triggering operation, a current video frame to be processed;
add, for a target object in the current video frame to be processed, a target effect; and
control, in response to meeting a linkage exhibiting condition, the target effect to be exhibited in linkage with the target object, for obtaining a target effect video.

The storage medium may be a non-transitory storage medium.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including the LAN or WAN, or the connection may be made to an external computer (for example, through the Internet using an Internet service provider).

The flowcharts and block diagrams in the accompanying drawings illustrate the architecture, functionality, and operation of possible implementations of systems, methods, and computer program products according to multiple embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. The name of the module or unit does not constitute a limitation of the unit itself under a circumstance. For example, the first acquisition unit may also be described as a “at least two internet protocol addresses acquisition unit”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, RAM, ROM, EPROM or flash memory, optical fiber, CD-ROM, optical storage device, magnetic storage device, or any suitable combination of the foregoing.

According to one or more embodiments, [Example 1] provides a method for determining an effect video, which includes:
acquiring, in response to an effect triggering operation, a current video frame to be processed;
adding, for a target object in the current video frame to be processed, a target effect; and
controlling, in response to meeting a linkage exhibiting condition, the target effect to be exhibited in linkage with the target object, for obtaining a target effect video.

According to one or more embodiments, [Example 2] provides a method for determining an effect video, in the method:
the adding, for a target object in the current video frame to be processed, a target effect, includes:
determining the target effect according to a target display attribute of the target object, in which the target display attribute comprises at least one of a global display attribute or a local display attribute; and
adding, for the target object, the target effect based on a target processing approach corresponding to the target effect.

According to one or more embodiments, [Example 3] provides a method for determining an effect video, in the method:
the adding, for the target object, the target effect based on a target processing approach corresponding to the target effect, includes:
determining, in response to the target effect being consistent with the global display attribute, a target limb key point corresponding to the target object; and
determining the target limb key point as a mount point of the target effect, and adding the target effect for the target object.

According to one or more embodiments, [Example 4] provides a method for determining an effect video, in the method:

the adding, for the target object, the target effect based on a target processing approach corresponding to the target effect, includes:

determining, in response to the target effect being consistent with the local display attribute, a partitioned sub-image corresponding to the target object; and determining the partitioned sub-image as target display content in the target effect.

According to one or more embodiments, [Example 5] provides a method for determining an effect video, in the method:

the linkage exhibiting condition comprises at least one of:

a triggering operation on a display interface to which the current video frame to be processed belongs;

there being no triggering operation on the display interface to which the current video frame to be processed belongs within a preset duration;

a target limb action of the target object being consistent with a preset limb action; and

a preset wake-up word being triggered by actual audio information of the target object.

According to one or more embodiments, [Example 6] provides a method for determining an effect video, in the method:

controlling the target effect to be exhibited in linkage with the target object, comprises:

controlling the target effect to be exhibited in linkage with the target object at a preset movement speed.

According to one or more embodiments, [Example 7] provides a method for determining an effect video, the method:

during controlling the target effect to be exhibited in linkage with the target object at a preset movement speed, further includes:

acquiring a current limb action of the target object, and determining a target movement speed matched with the current limb action; and

adjusting a speed of the exhibition in linkage from the preset movement speed to the target movement speed.

According to one or more embodiments, [Example 8] provides a method for determining an effect video, the method further includes:
adjusting, according to movement height information of the target object, a display ratio of the target effect and the target object in a display interface, during the exhibition in linkage.

According to one or more embodiments, [Example 9] provides a method for determining an effect video, the method further includes:
controlling, in response to detecting that the target object re-enters the display interface, the target effect to be exhibited in linkage with the target object.

According to one or more embodiments, [Example 10] provides a method for determining an effect video, the method further includes:
determining, during the exhibition in linkage, pixel points to be filled of the target object in a display interface; and
determining target pixel values of the pixel points to be filled, and obtaining at least one effect video frame in the target effect video.

According to one or more embodiments, [Example 11] provides a method for determining an effect video, in the method:
the determining, during the exhibition in linkage, pixel points to be filled of the target object in a display interface, includes:
determining, in response to a target display attribute of the target object being a global display attribute, the pixel points to be filled according to display information of the target object in a previous effect video frame and a current effect video frame; and
determining, in response to the target display attribute of the target object being a local display attribute, the pixel points to be filled according to display information of the target effect in the previous effect video frame and the current effect video frame.

According to one or more embodiments, [Example 12] provides a method for determining an effect video, in the method:
the determining target pixel values of the pixel points to be filled, and obtaining at least one effect video frame in the target effect video, comprises:
determining, according to the pixel points to be filled, edge pixel points;
determining, for each of the edge pixel points, pixel values within a neighborhood of a current edge pixel point, and determining, based on the pixel values within the neighborhood of the current edge pixel point, a target pixel value of the current edge pixel point;
determining, based on the target pixel value of each of the edge pixel points, a filled pixel value of each of the pixel points to be filled, and determining the filled pixel value as the target pixel value of the pixel point to be filled; and
obtaining, based on the target pixel value of the pixel point to be filled, an effect video frame in the target effect video.

According to one or more embodiments, [Example 13] provides a method for determining an effect video, in the method:
background information of each effect video frame in the target effect video is consistent with background information when colleting the target object.

According to one or more embodiments, [Example 14] provides a method for determining an effect video, the method further includes:
determining, in response to a number of objects to be processed in the current video frame to be processed is more than one, a target object to add the target effect for the target object, and controlling the target effect to be exhibited in linkage with the target object.

According to one or more embodiments, [Example 15] provides an apparatus for determining an effect video, the apparatus includes: a video frame acquiring module, an effect adding module, and an effect linkage exhibiting module.

The video frame acquiring module is configured to acquire, in response to an effect triggering operation, a current video frame to be processed.

The effect adding module is configured to add, for a target object in the current video frame to be processed, a target effect.

The effect linkage exhibiting module is configured to control, in response to meeting a linkage exhibiting condition, the target effect to be exhibited in linkage with the target object, for obtaining a target effect video.

It should be understood by those skilled in the art that the disclosure scope involved in the present disclosure is not limited to the embodiments formed by the specific combination of the above-mentioned technical features, but also other embodiments formed by any combination of the above-mentioned technical features or their equivalent features without departing from the above-mentioned disclosure concepts. For example, the above features are replaced with (but not limited to) technical features having similar functions disclosed in the present disclosure, so as to form an embodiment.

Furthermore, although the various operations are depicted in a particular order, it should not be understood as requiring that these operations be performed in the particular order as illustrated or in a sequential order. Under a certain circumstance, multitasking and parallel processing may be beneficial. Likewise, although multiple implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments separately or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are only exemplary forms of implementing the claims.

What is claimed is:

1. A method for determining an effect video, comprising:
acquiring, in response to an effect triggering operation, a current video frame to be processed;
adding, for a target object in the current video frame to be processed, a target effect; and
controlling, in response to meeting a linkage exhibiting condition, the target effect to be exhibited in linkage with the target object, for obtaining a target effect video.

2. The method according to claim 1, wherein the adding, for a target object in the current video frame to be processed, a target effect comprises:
determining the target effect according to a target display attribute of the target object; wherein the target display attribute comprises at least one of a global display attribute or a local display attribute; and
adding, for the target object, the target effect based on a target processing approach corresponding to the target effect.

3. The method according to claim 2, wherein the adding, for the target object, the target effect based on a target processing approach corresponding to the target effect comprises:
determining, in response to the target effect being consistent with the global display attribute, a target limb key point corresponding to the target object; and
determining the target limb key point as a mount point of the target effect, and adding the target effect for the target object.

4. The method according to claim 2, wherein the adding, for the target object, the target effect based on a target processing approach corresponding to the target effect comprises:
determining, in response to the target effect being consistent with the local display attribute, a partitioned sub-image corresponding to the target object; and
determining the partitioned sub-image as target display content in the target effect.

5. The method according to claim 1, wherein the linkage exhibiting condition comprises at least one of:
a triggering operation on a display interface to which the current video frame to be processed belongs;
there being no triggering operation on the display interface to which the current video frame to be processed belongs within a preset duration;
a target limb action of the target object being consistent with a preset limb action; and
a preset wake-up word being triggered by actual audio information of the target object.

6. The method according to claim 1, wherein controlling the target effect to be exhibited in linkage with the target object comprises:
controlling the target effect to be exhibited in linkage with the target object at a preset movement speed.

7. The method according to claim 6, during controlling the target effect to be exhibited in linkage with the target object at a preset movement speed, further comprising:
acquiring a current limb action of the target object, and determining a target movement speed matched with the current limb action; and
adjusting a speed of the exhibition in linkage from the preset movement speed to the target movement speed.

8. The method according to claim 1, further comprising:
adjusting, according to movement height information of the target object, a display ratio of the target effect and the target object in a display interface, during the exhibition in linkage.

9. The method according to claim 8, further comprising:
controlling, in response to detecting that the target object re-enters the display interface, the target effect to be exhibited in linkage with the target object.

10. The method according to claim 1, further comprising:
determining, during the exhibition in linkage, pixel points to be filled of the target object in a display interface; and
determining target pixel values of the pixel points to be filled, and obtaining at least one effect video frame in the target effect video.

11. The method according to claim 10, wherein the determining, during the exhibition in linkage, pixel points to be filled of the target object in a display interface comprises:
determining, in response to a target display attribute of the target object being a global display attribute, the pixel points to be filled according to display information of the target object in a previous effect video frame and a current effect video frame; and
determining, in response to the target display attribute of the target object being a local display attribute, the pixel points to be filled according to display information of the target effect in the previous effect video frame and the current effect video frame.

12. The method according to claim 10, wherein the determining target pixel values of the pixel points to be filled, and obtaining at least one effect video frame in the target effect video comprises:
determining, according to the pixel points to be filled, edge pixel points;
determining, for each of the edge pixel points, pixel values within a neighborhood of a current edge pixel point, and determining, based on the pixel values within the neighborhood of the current edge pixel point, a target pixel value of the current edge pixel point;
determining, based on the target pixel value of each of the edge pixel points, a filled pixel value of each of the pixel points to be filled, and determining the filled pixel value as the target pixel value of the pixel point to be filled; and
obtaining, based on the target pixel value of the pixel point to be filled, an effect video frame in the target effect video.

13. The method according to claim 1, wherein background information of each effect video frame in the target effect video is consistent with background information when colleting the target object.

14. The method according to claim 1, further comprising:
determining, in response to a number of objects to be processed in the current video frame to be processed is more than one, a target object to add the target effect for the target object, and controlling the target effect to be exhibited in linkage with the target object.

15. (canceled)

16. An electronic device, comprising:
one or more processors;
a storage apparatus, configured to store one or more programs,
wherein the one or more programs, when executed by the one or more processors, cause the one or more processors to:
acquire, in response to an effect triggering operation, a current video frame to be processed;
add, for a target object in the current video frame to be processed, a target effect; and
control, in response to meeting a linkage exhibiting condition, the target effect to be exhibited in linkage with the target object, for obtaining a target effect video.

17. A storage medium comprising computer-executable instructions, wherein the computer-executable instructions, when executed by a computer processor, are used to:
acquire, in response to an effect triggering operation, a current video frame to be processed;
add, for a target object in the current video frame to be processed, a target effect; and
control, in response to meeting a linkage exhibiting condition, the target effect to be exhibited in linkage with the target object, for obtaining a target effect video.

18. The electronic device according to claim 16, wherein the one or more processors is further configured to:
determine the target effect according to a target display attribute of the target object; wherein the target display attribute comprises at least one of a global display attribute or a local display attribute; and
add, for the target object, the target effect based on a target processing approach corresponding to the target effect.

19. The electronic device according to claim 18, wherein the one or more processors is further configured to:
determine, in response to the target effect being consistent with the global display attribute, a target limb key point corresponding to the target object; and
determine the target limb key point as a mount point of the target effect, and add the target effect for the target object.

20. The electronic device according to claim 18, wherein the one or more processors is further configured to:
determine, in response to the target effect being consistent with the local display attribute, a partitioned sub-image corresponding to the target object; and
determine the partitioned sub-image as target display content in the target effect.

21. The electronic device according to claim 16, wherein the linkage exhibiting condition comprises at least one of:
a triggering operation on a display interface to which the current video frame to be processed belongs;
there being no triggering operation on the display interface to which the current video frame to be processed belongs within a preset duration;
a target limb action of the target object being consistent with a preset limb action; and
a preset wake-up word being triggered by actual audio information of the target object.
